(19) United States
(12) Patent Application Publication
(10) Pub. No.: US 2024/0278133 A1
(43) Pub. Date: Aug. 22, 2024

(54) Virtual Object Control Methods and Systems

(71) Applicant: Tencent Technology (Shenzhen) Company Limited, Shenzhen (CN)

(72) Inventor: Yunpeng Guo, Shenzhen (CN)

(21) Appl. No.: 18/652,135

(22) Filed: May 1, 2024

Related U.S. Application Data
(63) Continuation of application No. PCT/CN2023/119289, filed on Sep. 18, 2023.

(30) Foreign Application Priority Data
Oct. 24, 2022 (CN) 2022113051877

(51) Int. Cl. A63F 13/58; A63F 13/46; A63F 13/537; A63F 13/822

(52) U.S. Cl. CPC A63F 13/58; A63F 13/46; A63F 13/537; A63F 13/822; A63F 2300/638

(57) ABSTRACT

A virtual object control method and apparatus, a device, a medium, and a product, relating to the field of virtual environments. The method includes: displaying a first virtual object and a plurality of enemy virtual objects engaged in a virtual battle in a first battle area in a virtual scene; adding and displaying, in response to that an enemy virtual object is eliminated by the second virtual object in the second battle area, the enemy virtual object in the first battle area; receiving an attack operation on an enemy virtual object in the first battle area; and displaying a virtual battle result between the first virtual object and the second virtual object based on a magnitude relationship in quantity between the enemy virtual objects in the first battle area and in the second battle area.

### RELATED APPLICATION

This application claims priority to PCT Application No. PCT/CN2023/119289, filed Sep. 18, 2023, which claims priority to Chinese Patent Application No. 202211305187.7, filed on Oct. 24, 2022, each entitled “VIRTUAL OBJECT CONTROL METHOD AND APPARATUS, DEVICE, MEDIUM, AND PRODUCT”, and each of which is incorporated herein by reference in its entirety.

### FIELD OF THE TECHNOLOGY

This application relates to the field of computer technologies, and in particular, to a virtual object control method and apparatus, a device, a medium, and a product.

### BACKGROUND OF THE DISCLOSURE

With rapid development of computer technologies and the diversification of terminals, electronic games are played by an increasing quantity of people. A massively multiplayer online role-playing game (MMORPG) is a popular game genre, in which a virtual scene is displayed on a terminal, and a player may perform a role activity by controlling a virtual object in the virtual scene.

In related art, a match between players is usually played by attacking each other. A player controls a virtual object to eliminate a virtual object controlled by an opponent player, to acquire corresponding points. The virtual object controlled by the opponent player is to be revived (e.g., respawn) at a specified location after a period of time, to implement loop fights of both players until the end of the match, and points acquired by the players are separately counted to determine a result of the match.

However, in related art, in a match where the result is determined based on points acquired by players by battling against each other within a specified period of match time, the form of direct battle between the players is monotonous. When there is strength disparity between players, a direct battle usually results in repeated loop battles between the two virtual objects, resulting in unnecessary data overhead of computers.

### SUMMARY

Aspects of this application provide a virtual object control method and apparatus, a device, a medium, and a product, to improve diversity of matches. Illustrative technical solutions are described below.

According to one aspect, a virtual object control method is provided. The method is performed by a computer device, and may include:
displaying a first virtual object and a first plurality of enemy virtual objects engaged in a virtual battle in a first battle area in a virtual scene, the virtual scene further including a second virtual object and a second plurality of enemy virtual objects engaged in a virtual battle in a second battle area;
adding and displaying, in response to an enemy virtual object being eliminated by the second virtual object in the second battle area, the enemy virtual object in the first battle area;
receiving an attack operation on an enemy virtual object in the first battle area, and adding, in response to the enemy virtual object being eliminated in the first battle area, the enemy virtual object in the second battle area; and
displaying a virtual battle result between the first virtual object and the second virtual object based on a magnitude relationship or comparison of a quantity of the enemy virtual objects in the first battle area and the enemy virtual objects in the second battle area.

According to another aspect, a virtual object control apparatus is provided. The apparatus includes:
a display module, configured to display a first virtual object and a first plurality of enemy virtual objects engaged in a virtual battle in a first battle area in a virtual scene, the virtual scene further including a second virtual object and a second plurality of enemy virtual objects engaged in a virtual battle in a second battle area, and
the display module being further configured to add and display, in response to an enemy virtual object being eliminated by the second virtual object in the second battle area, the enemy virtual object in the first battle area; and
a receiving module, configured to receive an attack operation on an enemy virtual object in the first battle area, and add, in response to the enemy virtual object being eliminated in the first battle area, the enemy virtual object in the second battle area,
the display module being further configured to display a virtual battle result between the first virtual object and the second virtual object based on a magnitude relationship or comparison of a quantity of the enemy virtual objects in the first battle area and the enemy virtual objects in the second battle area.

According to another aspect, a computer device is provided. The computer device includes a processor and a memory. The memory has at least one instruction, at least one program, a code set or an instruction set stored therein. The at least one instruction, the at least one program, and the code set or the instruction set are loaded and executed by the processor to implement the virtual object control method according to any one of aspects of this application.

According to another aspect, a non-transitory computer-readable storage medium is provided. The storage medium has at least one instruction, at least one program, a code set or an instruction set stored thereon. The at least one instruction, the at least one program, and the code set or the instruction set are loaded and executed by a processor to implement the virtual object control method according to any one of aspects of this application.

According to another aspect, a computer program product or a computer program is provided. The computer program product or the computer program includes computer instructions stored on a computer-readable storage medium. A processor of a computer device reads the computer instructions from the computer-readable storage medium, and the processor executes the computer instructions to enable the computer device to perform the virtual object control method according to any one of aspects.

The technical solutions provided in aspects of this application have at least the following beneficial effects.

In a first battle area in a virtual scene, there is a first virtual object and a first plurality of enemy virtual objects engaged in a virtual battle. In a second battle area, there is a second virtual object and a second plurality of enemy virtual objects engaged in a virtual battle. After an enemy virtual object in the second battle area is eliminated by the second virtual object, an enemy virtual object is added and displayed in the first battle area. Similarly, when an enemy virtual object is eliminated by the first virtual object by using an attack operation in the first battle area, an enemy virtual object is to be added and displayed in the second battle area. In other words, the first virtual object and the second virtual object eliminate enemy virtual objects in the first battle area and in the second battle area, respectively, to cause enemy virtual objects to be added and displayed in the battle area where the opponent is located. Finally, a virtual battle result is determined based on a magnitude relationship or comparison of a quantity of the enemy virtual objects in the two battle areas. Therefore, diversity of virtual battle modes can be improved, and the decrease or increase of enemy virtual objects of two parties is implemented by elimination of enemy virtual objects in each battle area, so that uncertainty of an indirect battle between virtual objects is increased. Cooperation and formations of different enemy virtual objects increase diversity of battles between the enemy virtual objects and the virtual objects, thereby avoiding data computing of repeated battles between the same virtual objects, and improving data computing effectiveness of computers.

### BRIEF DESCRIPTION OF THE DRAWINGS

FIG. 1 is a schematic diagram of an implementation environment according to one or more illustrative aspects described herein.

FIG. 2 is a block diagram of a structure of an electronic device according to one or more illustrative aspects described herein.

FIG. 3 is a flowchart of a virtual object control method according to one or more illustrative aspects described herein.

FIG. 4 is a flowchart of a virtual object control method according to one or more illustrative aspects described herein.

FIG. 5 is a schematic diagram of a progress indication element according to one or more illustrative aspects described herein.

FIG. 6 is a flowchart of a virtual object control method according to one or more illustrative aspects described herein.

FIG. 7 is a schematic diagram of a point redemption interface according to one or more illustrative aspects described herein.

FIG. 8 is a schematic diagram of a point redemption interface according to one or more illustrative aspects described herein.

FIG. 9 is a schematic diagram of a point redemption interface according to one or more illustrative aspects described herein.

FIG. 10 is a schematic diagram of a virtual object control method according to one or more illustrative aspects described herein.

FIG. 11 is a schematic diagram of an initial interface according to one or more illustrative aspects described herein.

FIG. 12 is a flowchart of a virtual object control method according to one or more illustrative aspects described herein.

FIG. 13 is a flowchart of a point redemption process according to one or more illustrative aspects described herein.

FIG. 14 is a block diagram of a structure of a virtual object control apparatus according to one or more illustrative aspects described herein.

FIG. 15 is a block diagram of a structure of a virtual object control apparatus according to one or more illustrative aspects described herein.

FIG. 16 is a block diagram of a structure of a terminal according to one or more illustrative aspects described herein.

### DETAILED DESCRIPTION ASPECT

Virtual environment: It is a virtual environment displayed (or provided) when an application runs on a terminal. The virtual environment may be a simulated environment of the real world, a semi-simulated and semi-fictional three-dimensional environment, or a completely fictional three-dimensional environment. The virtual environment may be any one of a two-dimensional virtual environment, a 2.5-dimensional virtual environment, and a three-dimensional virtual environment. An example in which the virtual environment is a two-dimensional virtual environment is used in the following aspects for description, but not for limitation.

Virtual object: It is a movable object in a virtual environment. The movable object may be a virtual chess piece, a virtual character, a virtual animal, and an animation character, or the like, for example, may be a character, an animal, a plant, an oil barrel, a wall, a stone, or the like displayed in a virtual environment. In one aspect, the virtual object is a three-dimensional model created based on a skeletal animation technology. Each virtual object has a shape and a volume in a virtual environment, and occupies some space in the virtual environment.

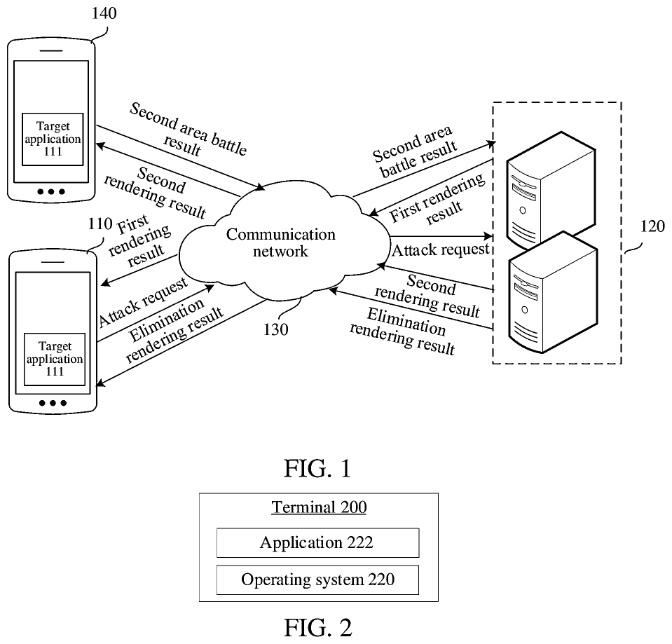

Next, an implementation environment of this application is described. FIG. 1 is a schematic diagram of an implementation environment according to an exemplary aspect of this application. The implementation environment includes: a terminal.

A first application is installed and runs on the terminal. The first application is an application that supports a two-dimensional virtual environment or a three-dimensional virtual environment. The first application may be any one of a virtual reality application, a three-dimensional map program, an auto chess game, a strategy game, a puzzle game, a third-person shooting (TPS) game, or a first-person shooting (FPS) game, a multiplayer online battle arena (MOBA) game, a multiplayer gun battle survival game, and a massively multiplayer online role-playing game. In an implementation, the first application may be a console version of an application, such as a console version of a three-dimensional game program, or may be an online version of an application.

In one aspect, in a case that the first application is implemented as a console version of an application, a first virtual object and a plurality of enemy virtual objects engaged in a virtual battle in a first battle area in a virtual scene are displayed in the current first application, and the virtual scene further includes a second virtual object and a plurality of enemy virtual objects engaged in a virtual battle in a second battle area. The first virtual object is a virtual object controlled by an account currently logged in on the terminal. Both the enemy virtual objects and the second virtual object are non-player characters (NPCs). The enemy virtual objects and the second virtual object are different types of NPCs battling each other. In response to an enemy virtual object being eliminated by the second virtual object in the second battle area, an enemy virtual object is added and displayed in the first battle area displayed on the terminal. When receiving an attack operation on an enemy virtual object in the first battle area, the terminal eliminates the enemy virtual object in the first battle area based on the attack operation, and then adds and displays an enemy virtual object in the second battle area. Finally, a virtual battle result (including that the first virtual object wins, or the first virtual object loses the match) corresponding to the first virtual object is determined based on a magnitude relationship in quantity between the enemy virtual objects in the two battle areas.

In one aspect, in a case that the first application is implemented as an online version of an application, the implementation environment includes: a first terminal 110, a second terminal 140, a server 120, and a communication network 130. The first terminal 110, the second terminal 140, and the server 120 are connected through the communication network 130. As shown in FIG. 1, the current first application is implemented as a massively multiplayer online role-playing game. The current first terminal 110 displays a first virtual object and a plurality of enemy virtual objects engaged in a virtual battle in a first battle area in a virtual scene, the virtual scene further including a second virtual object and a plurality of enemy virtual objects engaged in a virtual battle in a second battle area. The first virtual object is a virtual object controlled by a first account currently logged in on the first terminal 110. The second virtual object may be a virtual object controlled by another player, or may be an NPC. An example in which the second virtual object is a virtual object controlled by a second account logged in on the second terminal 140 is used for description, and the plurality of enemy virtual objects are NPCs.

When the second virtual object controlled by the second account eliminates an enemy virtual object in the second battle area, the second terminal 140 sends a second area battle result to the server 120. The second area battle result is used for indicating elimination of the enemy virtual objects in the second battle area, including an elimination quantity and an attribute value of each eliminated enemy virtual object.

In a case that a set of model rendering data respectively corresponding to a plurality of enemy virtual objects is stored on the server 120, after receiving the second area battle result, the server 120 acquires, from the set of model rendering data, model rendering data corresponding to the eliminated enemy virtual object in the second battle area, generates a first rendering result, and sends the first rendering result to the first terminal 110. After receiving the first rendering result sent by the server 120, the first terminal 110 adds and displays a corresponding enemy virtual object in the first battle area based on the model rendering result.

When receiving an attack operation on an enemy virtual object, the first terminal 110 generates an attack request and sends the attack request to the server 120 to request for eliminating the enemy virtual object in the first battle area. After receiving the attack request, the server 120 determines the eliminated enemy virtual object in the first battle area, acquires model rendering data and elimination rendering data corresponding to the enemy virtual object separately, sends the model rendering data to the second terminal 140 as a second rendering result, and sends the elimination rendering data to the first terminal 110 as an elimination rendering result. After receiving the elimination rendering result, the first terminal 110 renders, based on the elimination rendering data, the enemy virtual object hit by the attack operation, and displays an animation of eliminating the enemy virtual object. After receiving the second rendering result, the second terminal 140 adds and displays, based on the second rendering result, a corresponding enemy virtual object in the second battle area displayed on the second terminal 140.

The foregoing terminal may be selected from various forms of terminal devices such as a desktop computer, a portable laptop computer, a mobile phone, a tablet computer, an e-book reader, a Moving Picture Experts Group Audio Layer III (MP3) player, a Moving Picture Experts Group Audio Layer IV (MP4) player, a smart TV, and a smart on-board device, and is not limited in aspects of this application.

The server 120 includes at least one of a server, a plurality of servers, a cloud computing platform, and a virtualization center. In one aspect, the server 120 undertakes main computing work and the terminal 110 undertakes secondary computing work; or the server 120 undertakes secondary computing work and the terminal 110 undertakes main computing work; or a distributed computing architecture is used between the server 120 and the terminal 110 for collaborative computing.

The foregoing server may be an independent physical server, or may be a server cluster or a distributed system including a plurality of physical servers, or may be a cloud server that provides a basic cloud computing service such as a cloud service, a cloud database, cloud computing, a cloud function, cloud storage, a network service, a cloud communication, a middleware service, a domain name service, a security service, a content delivery network (CDN), and a big data and artificial intelligence platform.

A cloud technology refers to a hosting technology that unifies a series of resources such as hardware, software, and a network within a wide area network or local area network to implement data calculation, storage, processing, and sharing.

In some aspects, the foregoing server may alternatively be implemented as a node in a blockchain system.

Information (including but not limited to user equipment information, users' personal information, and the like), data (including but not limited to data used for analysis, stored data, displayed data, and the like), and signals involved in this application are all authorized by the users or fully authorized by all parties, and collection, use, and processing of related data need to comply with relevant laws, regulations, and standards of relevant countries and regions. For example, user information involved in this application are acquired under full authorization.

FIG. 2 is a block diagram of a structure of an electronic device according to an exemplary aspect of this application. A terminal 200 includes: an operating system 220 and an application 222.

The operating system 220 is basic software that enables secure access of the application 222 to computer hardware.

The application 222 is an application that supports a virtual environment. In one aspect, the application 222 is an application that supports a three-dimensional virtual environment.

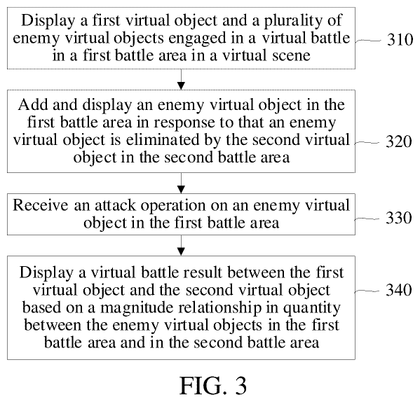

A virtual object control method provided by this application is described in combination with the foregoing introduction. The method may be performed by a server or a terminal, or may be jointly performed by a server and a terminal. In aspects of this application, the method is described by using an example in which the method is performed by a terminal. As shown in FIG. 3, the method includes the following steps.

Step 310. Display a first virtual object and a plurality of enemy virtual objects engaged in a virtual battle in a first battle area in a virtual scene.

The virtual scene further includes a second virtual object and a plurality of enemy virtual objects engaged in a virtual battle in a second battle area.

In some aspects, the first battle area includes one first virtual object, or the first battle area includes a plurality of first virtual objects. In a case that the first battle area includes a plurality of first virtual objects, there is a cooperation relationship or an alliance relationship between the plurality of first virtual objects. In other words, the plurality of first virtual objects constitute a virtual object team to fight virtual battles against the plurality of enemy virtual objects. Similarly, the second battle area includes one second virtual object, or the second battle area includes a plurality of second virtual objects. In a case that the second battle area includes a plurality of second virtual objects, there is a cooperation relationship or an alliance relationship between the plurality of second virtual objects. In other words, the plurality of second virtual objects constitute a virtual object team to fight virtual battles against the plurality of enemy virtual objects. Each of the first battle area and the second battle area may have one or more virtual objects. In a case that the first battle area includes one first virtual object, the second battle area includes one second virtual object; or in a case that the first battle area includes one first virtual object, the second battle area includes a plurality of second virtual objects; or in a case that the first battle area includes more than one first virtual object, the second battle area includes a plurality of second virtual objects. In a case that the second battle area includes one second virtual object, the first battle area includes one first virtual object; or in a case that the second battle area includes one second virtual object, the first battle area includes a plurality of first virtual objects; or in a case that the second battle area includes more than one second virtual object, the first battle area includes a plurality of first virtual objects. That is, there may be a one-to-one, one-to-many, or many-to-many relationship between virtual objects on each team.

For example, the first battle area is a virtual area that provides a battle environment for the first virtual object.

For example, the second battle area is a virtual area that provides a battle environment for the second virtual object.

In some aspects, the first virtual object refers to one or more virtual objects controlled by a first account currently logged in on the terminal, or the first virtual object includes a virtual object controlled by a first account currently logged in on the terminal and an allied virtual object of the virtual object.

In one aspect, the second virtual object refers to a virtual object controlled by a second account logged in on another terminal (such as a second terminal), or the second virtual object refers to a non-player character (NPC), and is not limited herein.

In some aspects, the enemy virtual objects are non-player character (NPCs) predetermined by the server.

The plurality of enemy virtual objects are virtual objects of the same type, or the plurality of enemy virtual objects are virtual objects of different types. For another example, the plurality of enemy virtual objects in the first battle area and the plurality of enemy virtual objects in the second battle area are virtual objects of the same type, or the plurality of enemy virtual objects in the first battle area and the plurality of enemy virtual objects in the second battle area are virtual objects of different types, and are not limited herein.

In one aspect, both the first battle area and the second battle area are displayed in a virtual scene picture currently displayed on the terminal. In other words, a user can intuitively view the battle in a battle area where a virtual object controlled by the user is located and the battle in a battle area where a virtual object controlled by the opponent is located. Alternatively, only the first battle area is displayed in a virtual scene picture currently displayed on the terminal. In other words, a user might only view the battle in a battle area where a virtual object controlled by the user is located. This is not limited herein.

In one aspect, the enemy virtual objects in the first battle area and the enemy virtual objects in the second battle area fight battles separately in respective battle areas. In other words, enemy virtual objects in the first battle area cannot move to the second battle area, and enemy virtual objects in the second battle area cannot move to the first battle area. Alternatively, the enemy virtual objects in the first battle area and the enemy virtual objects in the second battle area may move between the areas. For example, the enemy virtual objects in the first battle area may move to the second battle area to fight a virtual battle against the second virtual object.

In one aspect, the first virtual object and the second virtual object may move between the areas. For example, the first virtual object moves from the first battle area to the second battle area. Alternatively, the first virtual object and the second virtual object only fight virtual battles against the enemy virtual objects respectively in corresponding battle areas. Alternatively, the first virtual object changes the first battle area from a first position in the virtual scene to a second position in the virtual scene.

Step 320. Add and display an enemy virtual object in first battle area in response to that an enemy virtual object is eliminated by the second virtual object in second battle area.

For example, when the second virtual object in the second battle area performs an attack operation on an enemy virtual object, if an attribute value of the enemy virtual object hit by the attack operation reaches a preset attribute threshold (for example, health points of the enemy virtual object are 0), the enemy virtual object is to be in an eliminated state.

The eliminated state includes erasing the enemy virtual object from the second battle area, or displaying the enemy virtual object in an unattackable state in the second battle area (the unattackable state includes that the second virtual object cannot attack the enemy virtual object, or the enemy virtual object cannot attack the second virtual object), or moving the enemy virtual object out from the second battle area. This is not limited herein.

In some aspects, when an enemy virtual object is eliminated in the second battle area, an enemy virtual object is to be added and displayed in the first battle area. The enemy virtual object eliminated in the second battle area and the enemy virtual object added in the first battle area are the same enemy virtual object. For example, the enemy virtual object eliminated in the second battle area is added to the first battle area after the attribute values is reset. Alternatively, the enemy virtual object eliminated in the second battle area and the enemy virtual object added in the first battle area may be different enemy virtual objects. For example, after enemy virtual object a is eliminated in the second battle area, enemy virtual object b is added in the first battle area. This is not limited herein.

In one aspect, each time the second virtual object in the second battle area eliminates an enemy virtual object, an enemy virtual object is to be added and displayed in the first battle area synchronously. Alternatively, when a quantity of enemy virtual objects eliminated by the second virtual object in the second battle area reaches an elimination quantity threshold, enemy virtual objects corresponding to the elimination quantity in the second battle area are added and displayed in the first battle area. For example, when three enemy virtual objects are eliminated by the second virtual object in the second battle area, three enemy virtual objects are added and displayed in the first battle area. When the enemy virtual objects corresponding to the elimination quantity in the second battle area are added and displayed in the first battle area, a quantity of enemy virtual objects added and displayed in the first battle area is greater than the quantity of enemy virtual objects eliminated in the second battle area. Alternatively, a quantity of enemy virtual objects added and displayed in the first battle area is less than the quantity of enemy virtual objects eliminated in the second battle area. Alternatively, a quantity of enemy virtual objects added and displayed in the first battle area is equal to the quantity of enemy virtual objects eliminated in the second battle area. A corresponding magnitude relationship in quantity may be a preset proportional relationship, or preset one-to-one correspondence.

Steps 330. Receive an attack operation on an enemy virtual object in the first battle area.

The attack operation is for eliminating an enemy virtual object in the first battle area. An enemy virtual object is added in the second battle area based on the enemy virtual object eliminated in the first battle area.

In some aspects, the attack operation is for bringing effects on attribute values of the enemy virtual object, including, for example, at least one of the following effects: reducing health points of an enemy virtual object and weakening attack damage of the enemy virtual object, shortening display time of an enemy virtual objects, or moving an enemy virtual object out from the first battle area.

In one aspect, the attack operation may be implemented in at least one of the following manners:
1. The attack operation may be implemented by casting an attack skill on an enemy virtual object.
2. The attack operation may be implemented by using an attack prop against the enemy virtual object, such as using a virtual prop to attack the enemy virtual object.

The foregoing content about the attack operation is merely an example. The attack operation is not limited in aspects of this application.

For example, when the first virtual object in the first battle area performs an attack operation on the enemy virtual object, if the attack operation causes a state of the enemy virtual object to satisfy an elimination condition (for example, health points of the enemy virtual object are 0), the enemy virtual object is to be in an eliminated state.

The eliminated state includes erasing the enemy virtual object from the first battle area, or displaying the enemy virtual object in an unattackable state in the first battle area (the unattackable state includes that the first virtual object cannot attack the enemy virtual object, or the enemy virtual object cannot attack the first virtual object), or moving the enemy virtual object outside the first battle area. This is not limited herein.

In some aspects, when an enemy virtual object is eliminated in the first battle area, an enemy virtual object is to be added and displayed in the second battle area. The enemy virtual object eliminated in the first battle area and the enemy virtual object added in the second battle area may be the same enemy virtual object or different enemy virtual objects, which is not limited herein.

In one aspect, each time the first virtual object in the first battle area eliminates an enemy virtual object, an enemy virtual object is to be added and displayed in the second battle area synchronously. Alternatively, when a quantity of enemy virtual objects eliminated by the first virtual object in the first battle area reaches an elimination quantity threshold, enemy virtual objects corresponding to the elimination quantity in the first battle area are added and displayed in the second battle area. For example, only when three enemy virtual objects are eliminated by the first virtual object in the first battle area, three enemy virtual objects are added and displayed in the second battle area.

In some aspects, one single attack operation is only performed on one single enemy virtual object. Alternatively, one single attack operation may be performed on a plurality of enemy virtual objects simultaneously. This is not limited herein. In a case that the attack operation is implemented to be performed on a plurality of enemy virtual objects simultaneously, the plurality of enemy virtual objects hit by the attack operation may be affected to the same degree or different degrees.

In one aspect, the first virtual object and the second virtual object can only perform attack operations on the enemy virtual objects in the first battle area and the enemy virtual objects in the second battle area, respectively. Alternatively, the first virtual object may perform an attack operation on an enemy virtual object in the second battle area, and the second virtual object may perform an attack operation on an enemy virtual object in the first battle area. Alternatively, the first virtual object may provide assistance to the enemy virtual objects in the second battle area, and the second virtual object may provide assistance to the enemy virtual objects in the first battle area. This is not limited herein.

Step 340. Display a virtual battle result between the first virtual object and the second virtual object based on a magnitude relationship in quantity between the enemy virtual objects in the first battle area and in the second battle area.

For example, the magnitude relationship in quantity refers to a relationship between a quantity of surviving enemy virtual objects in the first battle area and a quantity of surviving enemy virtual objects in the second battle area. The relationship may include a proportional relationship, a magnitude relationship, a comparison relationship between a difference and a threshold, or the like, and is not limited in this aspect.

In one example, at the end of the match, when the quantity of surviving enemy virtual objects in the first battle area is less than the quantity of surviving enemy virtual objects in the second battle area, the virtual battle result is that the first virtual object wins the battle. In other words, the virtual battle result is determined based on comparison of the quantities of surviving enemy virtual objects in the two battle areas.

In one example, when the quantity of surviving enemy virtual objects in the first battle area reaches a survival quantity threshold (for example, 50 enemy virtual objects survive), and the quantity of surviving enemy virtual objects in the second battle area does not reach the survival quantity threshold, the virtual battle result is that the second virtual object wins the battle.

According to a virtual object control method provided by aspects of this application, in a virtual scene, there are a first virtual object and a plurality of enemy virtual objects engaged in a virtual battle in a first battle area, and there are a second virtual object and a plurality of enemy virtual objects engaged in a virtual battle in a second battle area. When an enemy virtual object in the second battle area is eliminated by the second virtual object, an enemy virtual object is added and displayed in the first battle area. Similarly, when an enemy virtual object is eliminated by the first virtual object by using an attack operation in the first battle area, an enemy virtual object is to be added and displayed in the second battle area. In other words, the first virtual object and the second virtual object eliminate enemy virtual objects in the first battle area and in the second battle area, respectively, to cause enemy virtual objects to be added and displayed in the battle area where the opponent is located. Finally, a virtual battle result is determined based on a magnitude relationship in quantity between the enemy virtual objects in the two battle areas. Therefore, diversity of virtual battle modes can be improved, and display of a decrease or increase of enemy virtual objects of two parties is implemented by elimination of enemy virtual objects in each battle area, so that uncertainty of an indirect battle between virtual objects is increased. Cooperation and formations of different enemy virtual objects increase diversity of battles between the enemy virtual objects and the virtual objects, thereby avoiding data computing of repeated battles between the same virtual objects, and improving data computing effectiveness of computers.

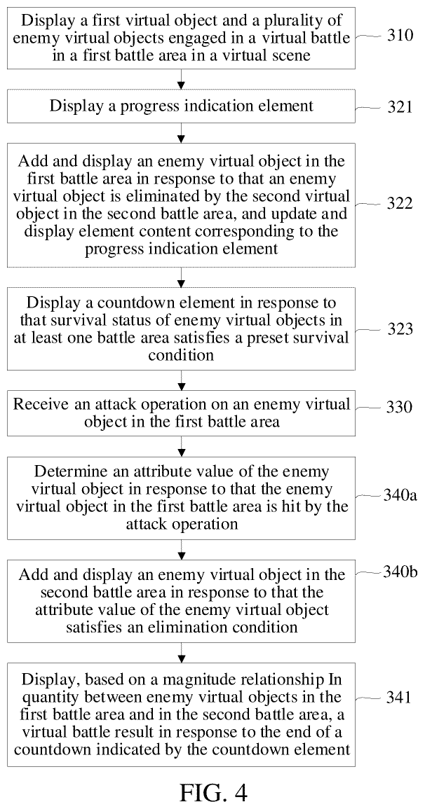

In one aspect, a progress indication element is further displayed in the current virtual scene picture. For example, refer to FIG. 4, which is a flowchart of a virtual object control method according to an illustrative aspect of this application. As shown in FIG. 4, step 320 includes step 321 to step 323; after step 330, the method further includes step 340a and step 340b; and step 340 further includes step 341. As shown in FIG. 4, the method includes the following steps.

Step 321. Display a progress indication element.

The progress indication element is used for indicating survival status of the enemy virtual objects in the first battle area.

In some aspects, the progress indication element is displayed in the virtual scene picture. A progress bar is displayed in the progress indication element, and a progress state of the progress bar is used for indicating the survival status of the enemy virtual objects in the first battle area.

For example, the survival status includes at least one of status such as a survival quantity, survival durations, and attribute values of enemy virtual objects.

In one example, in a case that the survival status is implemented as the survival quantity of enemy virtual objects, when the first virtual object eliminates at least one enemy virtual object in the first battle area, the length of a quantity progress bar in the progress indication element is shortened to indicate that the quantity of enemy virtual objects surviving currently is reduced. If at least one enemy virtual object is added and displayed in the first battle area, the length of the quantity progress bar in the progress indication element is increased to indicate that the quantity of enemy virtual objects surviving currently is increased.

In one example, in a case that the survival status is implemented as the survival durations of enemy virtual objects, the survival duration indicates a remaining survival time length of an enemy virtual object. Each enemy virtual object in the first battle area corresponds to one survival duration, and the starting time of the survival duration of the enemy virtual object is a time point when the enemy virtual object starts to be displayed in the first battle area. When the first virtual object performs an attack operation on an enemy virtual object, a survival duration progress bar of the enemy virtual object is displayed in the progress indication element, and the survival duration progress bar displayed before the enemy virtual object is eliminated gradually shortens to indicate that the survival duration of the enemy virtual object is gradually reduced.

In one example, in a case that the survival status is implemented as the attribute values of enemy virtual objects, the progress indication element is used for indicating an attribute value corresponding to an enemy virtual object that is attacked by the first virtual object currently in the first battle area. In other words, when the first virtual object performs an attack operation on an enemy virtual object in the first battle area, a progress indication element corresponding to the enemy virtual object is displayed in the current virtual scene picture. When the enemy virtual object is hit by the attack operation, an attribute progress bar displayed in the progress indication element is shortened to indicate that the attribute value of the current enemy virtual object is reduced.

In one aspect, a first progress indication element is displayed in the current virtual scene picture, to indicate the survival status of the enemy virtual objects in the first battle area. In addition, a second progress indication element is displayed in the current virtual scene picture, to indicate the survival status of the enemy virtual objects in the second battle area. This is not limited herein.

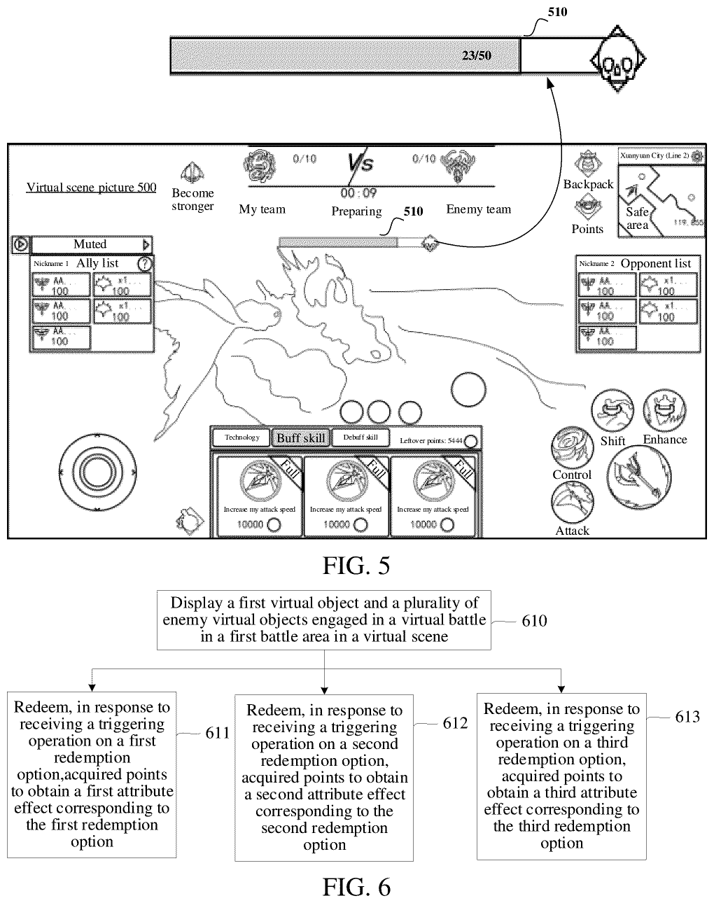

For example, refer to FIG. 5, which is a schematic diagram of a progress indication element according to an illustrative aspect of this application. As shown in FIG. 5, a virtual scene picture 500 is currently displayed. A progress indication element 510 is displayed in the virtual scene picture 500 to indicate a survival quantity of enemy virtual objects in a current first battle area. “23” in the progress indication element 510 indicates a corresponding quantity of the surviving enemy virtual objects in the current first battle area.

In this aspect, displaying the progress indication element enables a user to more intuitively learn survival status of the current enemy virtual objects in the first battle area, so that the user can easily learn the distribution of enemy virtual objects in the first battle area and adjust an attack strategy, thereby reducing data overhead of a computer.

Step 322. Add and display an enemy virtual object at a random position in the first battle area in response to an enemy virtual object being eliminated by the second virtual object in the second battle area, and update and display element content corresponding to the progress indication element.

For example, after the enemy virtual object in the second battle area is eliminated by the second virtual object, an enemy virtual object is added and displayed at a random position in the first battle area. For example, after enemy virtual object 1 in the second battle area is eliminated, enemy virtual object 1 is added and displayed at position a in the first battle area, and after enemy virtual object 2 in the second battle area is eliminated, enemy virtual object 2 is added and displayed at position point b in the first battle area.

In one aspect, when a plurality of enemy virtual objects in the second battle area are eliminated simultaneously, a plurality of enemy virtual objects are added and displayed at the same random position in the first battle area. Alternatively, a plurality of enemy virtual objects are added and displayed at different random positions in the first battle area. This is not limited herein.

In one example, when the survival status is implemented as the survival quantity of enemy virtual objects in the first battle area, when an enemy virtual object in the second battle area is eliminated by the second virtual object, the length of a quantity progress bar in the progress indication element is increased, to indicate that the quantity of enemy virtual objects surviving currently in the first battle area is increased.

In one example, when the survival status is implemented as the survival durations of enemy virtual objects in the first battle area, when an enemy virtual object in the second battle area is eliminated by the second virtual object, the survival duration progress bar in the progress indication element is updated and displayed as the survival duration corresponding to the enemy virtual object added and displayed in the first battle area.

In one example, when the survival status is implemented as the attribute values of enemy virtual objects in the first battle area, when an enemy virtual object in the second battle area is eliminated by the second virtual object, the attribute value progress bar in the progress indication element is updated and displayed as an initial attribute value corresponding to the enemy virtual object added and displayed in the first battle area. The initial attribute value refers to a corresponding attribute value when the enemy virtual object currently added and displayed has not been hit by an attack operation.

In this aspect, when an enemy virtual object in the second battle area is eliminated by the second virtual object, an enemy virtual object is displayed at a random position in the first battle area, so that a user cannot predict a display position of the enemy virtual object in advance, thereby improving playability of a game and facilitating attack strategy adjustment of the user in a timely manner.

In this aspect, update status of the progress indication element is associated with the enemy virtual objects added and displayed in the current first battle area, to allow the user to easily learn the survival status of the enemy virtual objects in the current first battle area in a timely manner.

Step 323. Display a countdown element in response to the survival status of enemy virtual objects in at least one battle area satisfies a preset survival condition.

The countdown element is used for indicating a remaining duration from a current moment to the end of a virtual battle.

For example, a countdown is displayed in the countdown element to indicate the remaining duration from a current moment to the end of the virtual match.

In one example, in a case that the survival status is implemented as the survival quantity of enemy virtual objects in the first battle area, and the preset survival condition is that the survival quantity reaches a preset survival quantity threshold, the countdown element is displayed. For example, when the survival quantity of enemy virtual objects in the first battle area reaches 50, a countdown element “5 seconds” is displayed. Alternatively, in a case that the survival status is implemented as the survival quantity of enemy virtual objects in the second battle area, and the preset survival condition is that the survival quantity reaches a preset survival quantity threshold, the countdown element is displayed. The first battle area is only used as an example for illustrative purposes, and this is not limited in the following aspects.

In one example, when the survival status is implemented as the survival duration of the enemy virtual object in the first battle area, and the preset survival condition is that the survival duration reaches a preset survival duration threshold, the countdown element is displayed. For example, when the remaining survival duration of an enemy virtual object in the first battle area is less than 30 seconds, the countdown element “5 seconds” is displayed.

In one example, in a case that the survival status is implemented as the attribute values of enemy virtual objects in the first battle area, and the preset survival condition is that the attribute value reaches a preset attribute value threshold, the countdown element is displayed. For example, when health points of an enemy virtual object in the first battle area is lower than 100, the countdown element “5 seconds” is displayed.

In this aspect, end time of the virtual match is correlated to the survival status of the enemy virtual objects, to avoid a fixed time length of each virtual match, so that the user can formulate relevant game strategies to shorten the time length of the match and win the match as quickly as possible, thereby reducing data overhead of a computer.

Step 340a. Determine an attribute value of the enemy virtual object in response to that the enemy virtual object in the first battle area is hit by the attack operation.

In one aspect, when the first virtual object performs an attack operation on an enemy virtual object in the first battle area, a remaining attribute value of the enemy virtual object after being hit by the attack operation is determined based on attack damage corresponding to the attack operation. Alternatively, each enemy virtual object has a different effect on an attribute value after being hit by an attack operation. When the first virtual object performs an attack operation on an enemy virtual object in the first battle area, the effect of the enemy virtual object on the attribute value is obtained based on the enemy virtual object that is indeed hit by the attack operation, to determine the attribute value of the enemy virtual object.

In one example, when the first virtual object performs an attack operation on an enemy virtual object in the first battle area, when the attack damage of the attack operation is “health points of the hit enemy virtual object are reduced by 100 points”, if the enemy virtual object has 120 health points before being hit by the attack operation, then the health points of the enemy virtual object are reduced to 20 points after being hit by the attack operation.

For example, when a terminal receives an instruction for performing an attack operation on a specified enemy virtual object, the terminal sends an object identifier corresponding to the specified enemy virtual object to a server. After receiving the object identifier, the server determines a position of the enemy virtual object in the first battle area, and determines a positional relationship between the first virtual object and the specified enemy virtual object. If the position relationship satisfies a hit condition, it is determined that the specified enemy virtual object is hit by the attack operation, and a hit result is fed back to the terminal.

In this aspect, the attribute value corresponding to the enemy virtual object in the first battle area is determined by different methods, so that efficiency and accuracy of eliminating the enemy virtual object can be improved.

Step 340b. Add and display an enemy virtual object in the second battle area in response to that the attribute value of the enemy virtual object satisfies an elimination condition.

For example, the elimination condition is used for determining whether a current enemy virtual object satisfies an elimination qualification.

In one example, when the first virtual object performs an attack operation on an enemy virtual object in the first battle area, in a case that the attack damage of the attack operation is “health points of the hit enemy virtual object are reduced by 100 points”, if the enemy virtual object has 80 health points before being hit by the attack operation, then the health points of the enemy virtual object are reduced to −20 points after being hit by the attack operation. In a case that the elimination condition is “health points of an enemy virtual object are <=0”, the health points of the enemy virtual object are lower than 0 points, and the enemy virtual object satisfies the elimination condition. Therefore, an enemy virtual object is added and displayed in the second battle area.

In this aspect, the enemy virtual object added and displayed in the second battle area is determined based on a preset elimination condition, so that an elimination process of the enemy virtual object is more in line with an objective of improving user experience, and playability of a game is improved.

In some aspects, an elimination quantity of enemy virtual objects in the first battle area is counted to obtain an elimination count result corresponding to the enemy virtual objects in the first battle area. In response to that the elimination count result reaches a first quantity threshold, additional enemy virtual objects are added and displayed in the second battle area, and the elimination count result is reset. That the elimination count result is reset means clearing the elimination count result and resetting the elimination count result to an initial value, such as 0.

For example, a counter is preset in the server. When enemy virtual objects in the first battle area are eliminated, the counter in the server counts the elimination quantity of eliminated enemy virtual objects, to obtain the elimination count result corresponding to the enemy virtual objects in the first battle area. When the elimination count result reaches the first quantity threshold, in addition to enemy virtual objects corresponding to an elimination quantity of enemy virtual objects in the first battle area, the enemy virtual objects added and displayed in the second battle area may further include an additional enemy virtual object, or the quantity of enemy virtual objects added and displayed in the second battle area may be less than that eliminated in the first battle area. For example, when the elimination quantity of enemy virtual objects in the first battle area reaches 5, in addition to five additional enemy virtual objects added and displayed, once additional enemy virtual object is to be added and displayed in the second battle area. For another example, each time the elimination quantity of enemy virtual objects in the first battle area reaches 5, in addition to five enemy virtual objects added and displayed, one additional enemy virtual object is to be added and displayed in the second battle area. In addition, after the additional enemy virtual object is added and displayed in the second battle area, the server clears the elimination count result and restarts counting.

In this aspect, additionally displaying enemy virtual objects in the second battle area based on the quantity of enemy virtual objects eliminated by the first virtual object can stimulate a user's interest in fighting against the enemy virtual objects. In addition, the method of additionally displaying enemy virtual objects can increase a total quantity of enemy virtual objects in the two battle areas, thereby speeding up the match, improving efficiency of the match, and reducing data overhead of a computer.

For example, a set of display models corresponding to different enemy virtual objects is preset in the server, and each display model corresponds to a different quantity of displayed model faces. The quantity of displayed model faces is used for indicating a quantity of model faces of an enemy virtual object displayed in the battle area. More displayed model faces of a virtual object indicates a more realistic display effect of the virtual object.

When an enemy virtual object is added and displayed in the second battle area, the server first determines a display position of the enemy virtual object in the second battle area, determines, based on a display angle corresponding to the display position in a scene picture, multiple quantities of displayed model faces that match the display angle, selects from the multiple quantities of displayed model faces a target display model having a smallest quantity of displayed model faces as a display model corresponding to the enemy virtual object added and displayed in the second battle area, and renders the target display model in the virtual scene picture based on the target display model.

In this aspect, the display position is determined by determining a spawn point of the enemy virtual object in the battle area, and then the display model that satisfies the display angle and has the smallest quantity of displayed model faces is selected in the server to perform rendering. In this way, more enemy virtual objects can be displayed, while ensuring smooth operation of the server.

In some aspects, a combined virtual object is added and displayed in the second battle area in response to that the elimination quantity of enemy virtual objects in the first battle area reaches a third quantity threshold, an attribute value of the combined virtual object corresponding to a sum of attribute values of the eliminated enemy virtual objects in the first battle area.

For example, the combined virtual object is a virtual object generated from a combination of a plurality of enemy virtual objects.

For example, in a case that the elimination quantity of enemy virtual objects in the first battle area reaches the third quantity threshold, the enemy virtual object added and displayed in the second battle area is implemented as the virtual object generated from a combination of the enemy virtual objects eliminated in the first battle area. For example, when three first-level minions are eliminated in the first battle area, a third-level minion may be displayed in the second battle area.

In this aspect, adding and displaying a combined virtual object in the second battle area based on the quantity of enemy virtual objects eliminated by the first virtual object can not only stimulate a player's interest in match, but also add and display one combined virtual object in the second battle area when a plurality of enemy virtual objects are eliminated in the first battle area. In this way, only one single combined virtual object needs to be rendered in the second battle area, thereby reducing data rendering overhead of a computer.

Step 341. Display, based on a magnitude relationship in quantity between enemy virtual objects in the first battle area and in the second battle area, a virtual battle result in response to the end of a countdown indicated by the countdown element.

For example, when the countdown indicated by the countdown element ends, it indicates that the current virtual match ends. The server separately calculates the survival quantity of enemy virtual objects in the first battle area and the survival quantity of enemy virtual objects in the second battle area at the current moment, and determines the virtual battle result between the first virtual object and the second virtual object based on the magnitude relationship in quantity between the enemy virtual objects in the first battle area and in the second battle area.

In one aspect, when an enemy virtual object is eliminated, redemption points can be acquired. For example, refer to FIG. 6, which is a flowchart of a virtual object control method according to an exemplary aspect of this application. As shown in FIG. 6, the method includes the following steps.

Step 610. Display a point redemption interface.

The point redemption interface includes a plurality of candidate redemption options, the candidate redemption options being used for obtaining match attribute effects by redeeming points, and the points being acquired by eliminating an enemy virtual object.

For example, an example in which a first account currently logged in on a terminal controls a first virtual object is used. When the first virtual object eliminates an enemy virtual object in a first battle area, the first account acquires corresponding redemption points based on the eliminated enemy virtual object, to redeem the redemption points for a corresponding match attribute effect during a virtual match.

In some aspects, a user performs a triggering operation on a candidate redemption option in the point redemption interface, and obtains the match attribute effect corresponding to the candidate redemption option when a quantity of redemption points reaches a point redemption condition corresponding to the candidate redemption option.

In one aspect, the match attribute effect includes an effect generated on the first virtual object, or an effect generated on enemy virtual objects, or an effect generated on a second virtual object. This is not limited herein.

In some aspects, the point redemption interface includes a plurality of redemption type options, including a first redemption option (this redemption type is used for redeeming for a match attribute effect generated on enemy virtual objects), a second redemption option (this redemption type is used for redeeming for a match attribute effect generated on the first virtual object), and a third redemption option (this redemption type is used for redeeming for a match attribute effect generated on the second virtual object).

The first redemption option includes a plurality of first candidate redemption options; the second redemption option includes a plurality of second candidate redemption options; and the third redemption option includes a plurality of third candidate redemption options.

In this aspect, redemption points are acquired by eliminating enemy virtual objects and a match attribute effect is obtained by using the redemption points, so that match diversity of the virtual match is improved. In addition, redemption for match attribute effects can speed up the match and improve efficiency of the match.

The following describes the three different redemption type options in detail.

In a first case, the first redemption option is displayed in the point redemption interface.

Step 611. Redeem, in response to receiving a triggering operation on a first redemption option, acquired points to obtain a first attribute effect corresponding to the first redemption option.

The first attribute effect is used for indicating generating a first buff effect on enemy virtual objects.

For example, the point redemption interface currently displayed includes the first redemption option, the second redemption option, and the third redemption option. When the triggering operation on the first redemption option is received, the plurality of first candidate redemption options are displayed in the point redemption interface. The plurality of first candidate redemption options are used for generating different match attribute effects on enemy virtual objects.

The plurality of first candidate redemption options respectively correspond to different point redemption conditions. If the redemption points that the first account currently has satisfy the foregoing point redemption conditions, the plurality of first candidate redemption options are displayed in an available state. If the redemption points do not satisfy a point redemption condition corresponding to a specific first candidate redemption option, the first candidate redemption option is displayed in an unavailable state. In other words, the first candidate redemption option cannot be triggered.

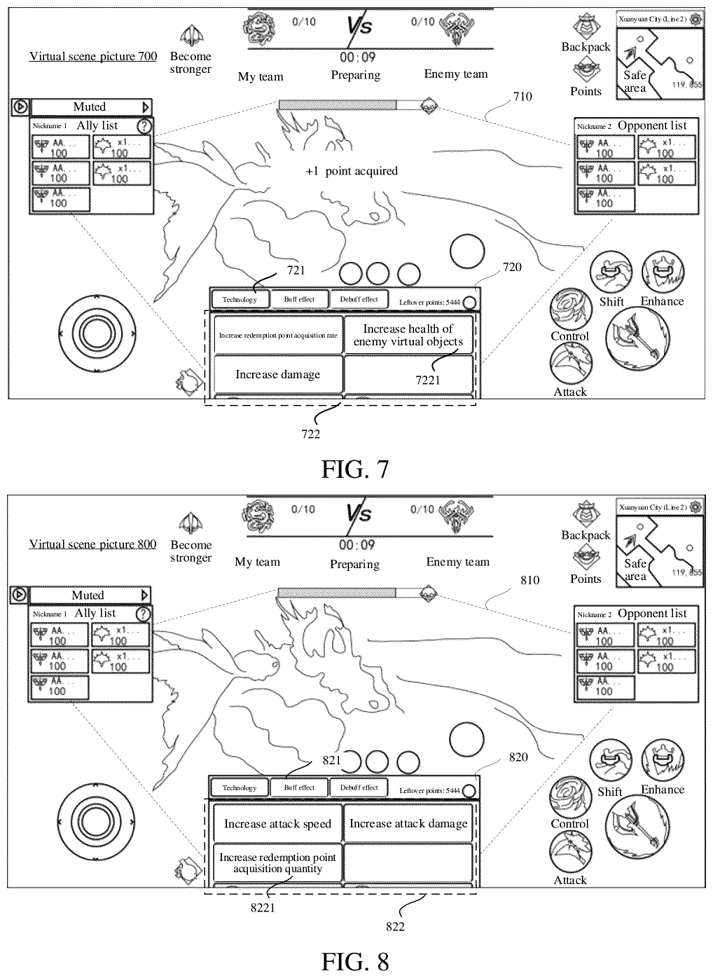

For example, refer to FIG. 7, which is a schematic diagram of a point redemption interface according to an exemplary aspect of this application. As shown in FIG. 7, a virtual scene picture 700 is currently displayed. A first battle area 710 is displayed in the virtual scene picture 700. There is a first virtual object and an enemy virtual object engaged in a virtual battle in the first battle area 710. When the first virtual object eliminates the enemy virtual object, a first account acquires redemption points, and a point redemption result is displayed in the virtual scene picture 700. Display content of the point redemption result is “+1 point acquired”, indicating that one redemption point is currently acquired.

In addition, a point redemption interface 720 is further displayed in the virtual scene picture 700. When a triggering operation on a first redemption type option 721 in the point redemption interface 720 is received, a plurality of first candidate redemption options 722 are displayed, including three options: “increase redemption point acquisition rate”, “increase health of enemy virtual objects”, and “increase damage”. “Increase redemption point acquisition rate” means to increase the rate of acquiring redemption points by the first virtual object after eliminating an enemy virtual object in the first battle area (for example, the rate is increased from taking 0.8 seconds to acquire one redemption point to taking 0.3 seconds to acquire one redemption point). “Increase health of enemy virtual objects” means that health points of enemy virtual objects subsequently added and displayed in the first battle area are to increase. “Increase damage” refers to increasing a damage value of the enemy virtual object in the current first battle area to the first virtual object.

When a triggering operation on a first redemption option 7221, that is, “reduce health of enemy virtual objects”, is received, and a point redemption condition of the first redemption option 7221 is “50 redemption points”, the first account that currently has 58 redemption points satisfies the point redemption condition, and therefore can obtain the first attribute effect corresponding to the first redemption option 7221, to reduce the health points of the enemy virtual objects subsequently added and displayed in the first battle area.

In some aspects, a target enemy virtual object is added and displayed, based on the first buff effect, in the first battle area in response to that the enemy virtual object is eliminated by the second virtual object in the second battle area. An attribute value of the target enemy virtual object corresponds to the first buff effect.

For example, because the first redemption option is implemented as “reduce health of enemy virtual objects”, when an enemy virtual object is eliminated by the second virtual object in the second battle area, a target enemy virtual object is added and displayed in the first battle area. Health points of the enemy virtual object are “500”, while health points of the target enemy virtual object are “250”.

In this aspect, generating match attribute effects on the enemy virtual objects via redemption can improve match difficulty of a virtual match between a virtual object controlled by a player and an enemy virtual object. In addition, the match difficulty can be freely adjusted based on user's wishes, so that the player can adjust strategies in a timely manner, thereby improving playability.

In a second case, the second redemption option is displayed in the point redemption interface.

Step 612. Redeem, in response to receiving a triggering operation on a second redemption option, acquired points to obtain a second attribute effect corresponding to the second redemption option.

The second attribute effect is used for generating a second buff effect on the first virtual object.

For example, when the triggering operation on the second redemption option is received, the plurality of second candidate redemption options are displayed in the point redemption interface. The plurality of second candidate redemption options are used for generating different match attribute effects on the first virtual object.

The plurality of second candidate redemption options respectively correspond to different point redemption conditions. If the redemption points that the first account currently has satisfy the foregoing point redemption conditions, the plurality of second candidate redemption options are displayed in an available state. If the redemption points do not satisfy a point redemption condition corresponding to a specific second candidate redemption option, the second candidate redemption option is displayed in an unavailable state. In other words, the second candidate redemption option cannot be triggered.

In one aspect, an attribute buff effect generated on the first virtual object includes at least one effect such as increasing health points of the first virtual object, increasing attack damage, increasing attack speed, or increasing a redemption point acquisition quantity or rate.

For example, refer to FIG. 8, which is a schematic diagram of a point redemption interface according to an illustrative aspect of this application. As shown in FIG. 8, a virtual scene picture 800 is currently displayed. A first battle area 810 is displayed in the virtual scene picture 800. There is a first virtual object and an enemy virtual object engaged in a virtual battle in the first battle area 810. When the first virtual object eliminates the enemy virtual object, a first account acquires redemption points.

In addition, a point redemption interface 820 is further displayed in the virtual scene picture 800. When a triggering operation on a second redemption type option 821 in the point redemption interface 820 is received, a plurality of second candidate redemption options 822 are displayed, including three options: “increase attack speed”, “increase attack damage”, and “increase redemption point acquisition quantity”. “Increase redemption point acquisition quantity” indicates that a quantity of redemption points acquired subsequently by eliminating an enemy virtual object by the first virtual object in the first battle area is to be increased (for example, the quantity of redemption points to be acquired is increased from one redemption point to five redemption points).

When a triggering operation on a second redemption option 8221, that is, “increase redemption point acquisition quantity”, is received, and a point redemption condition of the second redemption option 8221 is “100 redemption points”, in a case that the first account currently has 120 redemption points, the first account satisfies the point redemption condition, and therefore can obtain the second attribute effect corresponding to the second redemption option 8221, to increase the quantity of redemption points acquired by the first virtual object subsequently by eliminating an enemy virtual object in the first battle area.

In this aspect, the attribute buff effect is generated on the first virtual object by triggering the second redemption option, so that a time length of the match can be shortened, to improve efficiency of the match.

In a third case, the third redemption option is displayed in the point redemption interface.

Step 613. Redeem, in response to receiving a triggering operation on a third redemption option, acquired points to obtain a third attribute effect corresponding to the third redemption option.

The third attribute effect is used for generating an attribute debuff effect on the second virtual object.

For example, when the triggering operation on the third redemption type option is received, the plurality of third candidate redemption options are displayed in the point redemption interface. The plurality of third candidate redemption options are used for generating different match attribute effects on the second virtual object.

The plurality of third candidate redemption options respectively correspond to different point redemption conditions. If the redemption points that the first account currently has satisfy the foregoing point redemption conditions, the plurality of third candidate redemption options are displayed in an available state. If the redemption points do not satisfy a point redemption condition corresponding to a specific first candidate redemption option, the third candidate redemption option is displayed in an unavailable state. In other words, the third candidate redemption option cannot be triggered.

In one aspect, the attribute debuff effect generated on the second virtual object includes at least one effect such as temporarily preventing the second virtual object from playing (e.g., “stun” the second virtual object), reducing health points of the second virtual object, or canceling the attribute buff effect added for the second virtual object.

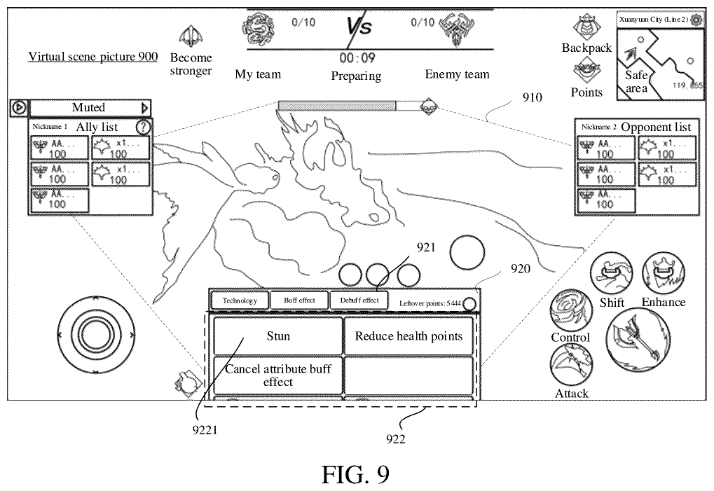

For example, refer to FIG. 9, which is a schematic diagram of a point redemption interface according to an exemplary aspect of this application. As shown in FIG. 9, a virtual scene picture 900 is currently displayed. A first battle area 910 is displayed in the virtual scene picture 900. There is a first virtual object and an enemy virtual object engaged in a virtual battle in the first battle area 910. When the first virtual object eliminates the enemy virtual object, a first account acquires redemption points.

In addition, a point redemption interface 920 is further displayed in the virtual scene picture 900. When a triggering operation on a third redemption type option 921 in the point redemption interface 920 is received, a plurality of third candidate redemption options 922 are displayed, including three options: “stun”, “reduce health points”, and “cancel attribute buff effect”. “Stun” means to stun the second virtual object for 5 seconds. The second virtual object cannot play the virtual match within 5 seconds. “Reduce health points” means to reduce health points corresponding to the second virtual object. “Cancel attribute buff effect” means to cancel all or part of the attribute buff effect added by the second account for the second virtual object (refer to the foregoing option content of the second candidate redemption option).

When a triggering operation “stun” on a third redemption option 9221 is received, and a point redemption condition of the third redemption option 9221 is “30 redemption points”, in a case that the first account currently has 90 redemption points, the first account satisfies the point redemption condition, and can obtain the third attribute effect corresponding to the third redemption option 9221, to stun the second virtual object for 5 seconds. The second virtual object cannot play the virtual match within 5 seconds.

In this aspect, the attribute debuff effect is generated on the second virtual object by triggering the third redemption option, so that match interference can be generated on the second account, to improve a match win rate of the first account and shorten a time length of the match, to improve efficiency of the match.

In some aspects, a redemption point acquisition rate is determined in response to that the survival quantity of surviving enemy virtual objects in the first battle area reaches a second quantity threshold; and redemption points are acquired based on the redemption point acquisition rate.

For example, in response to that the survival quantity of surviving enemy virtual objects in first battle area reaches the second quantity threshold, a rate of acquiring redemption points by the first account is to increase. For example, when there is no enemy virtual object in the first battle area, the first account can acquire 100 points per second.

In this aspect, the survival quantity of enemy virtual objects is related to the redemption point acquisition rate, to increase a user's interest in the match, thereby improving efficiency of the match, shortening the time length of the match, and reducing data overhead of a computer.

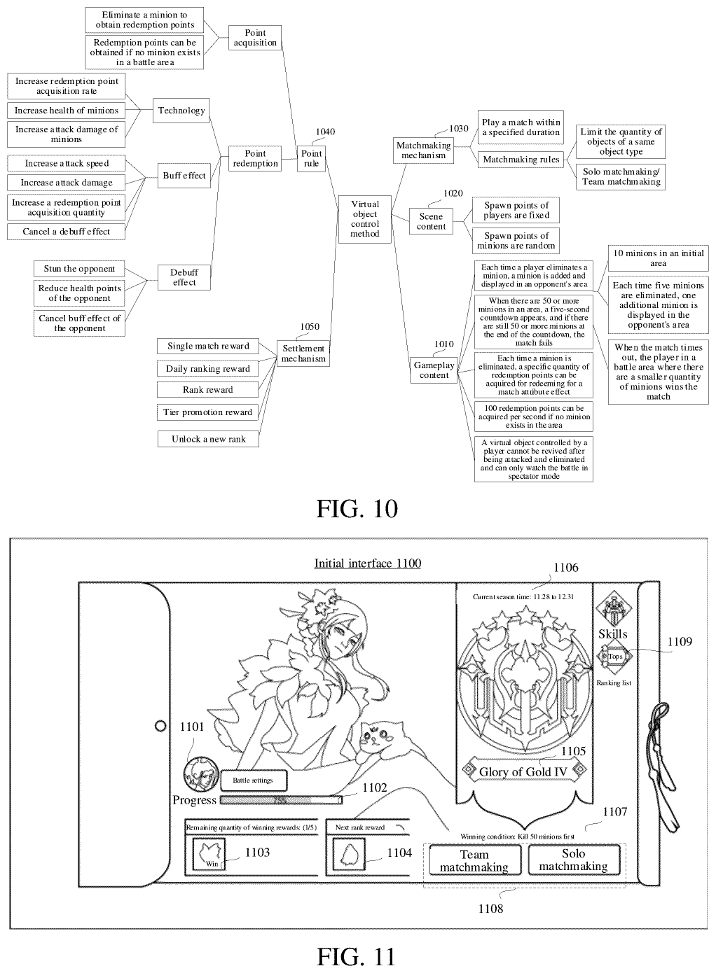

In one aspect, for example, refer to FIG. 10, which is a schematic diagram of a virtual object control method according to an illustrative aspect of this application. As shown in FIG. 10, an example in which the method is applied to a scenario of a massively multiplayer online role-playing game is used for description, and gameplay is mainly described.

The current virtual object control method includes gameplay content 1010, scene content 1020, a matchmaking mechanism 1030, point rules 1040, and a settlement mechanism 1050, which are described below in sequence.

Initial interface content is first introduced.

An avatar corresponding to a first account in a match, a progress of a game mission, a reward for winning the match, and a rank promotion reward are displayed on the left side of the initial interface.

An account level, match opening time, a condition for winning the match, a match mode, and a match result ranking list are displayed on the right side of the initial interface.

For example, refer to FIG. 11, which is a schematic diagram of an initial interface according to an exemplary aspect of this application. As shown in FIG. 11, an initial interface 1100 is currently displayed. The initial interface 1100 is a game interface before a match starts. An example in which the current initial interface 1100 is an interface of login with a first account is used for description. An account avatar 1101, a progress of a game mission 1102 (indicating a progress of completing a game mission), a reward for winning the match 1103 (a medal of honor may be acquired after winning 5 times), and a rank promotion reward 1104 are displayed on the left side of the initial interface 1100.

An account level 1105 (Glory of Gold IV), game opening time 1106 (the virtual match may be played from 11.28 to 12.31), a condition for winning the match 1107 (eliminating 50 enemy virtual objects first), a match mode 1108 (team matchmaking or solo matchmaking, where in a case of team matchmaking, a first virtual object and a plurality of allied virtual objects are to be included in a first battle area and jointly attack enemy virtual objects), and a match result ranking list 1109 are displayed on the right side of the initial interface 1100.

### 1. Gameplay Content 1010

### (1) Match Rules

Each time a minion is eliminated in a player's area, one minion is to be added in the opponent's area.

In this aspect, an enemy virtual object is implemented as a minion.

There are ten minions in each battle area at the beginning. When a player/the opponent eliminates five minions, one minion is added in the opponent/player's area.

When there are 50 or more minions in any area, a countdown element is displayed. If the minions in the area are not reduced to less than 50 before a countdown ends, a player in the area loses the match.

If there are 50 or more monsters in both areas, the player in the area, for which a countdown ends first, loses the match.

The match lasts for ten minutes. If the time is out, a player in the area having a smaller quantity of minions wins the match.

If there is no minion in an area, a player in the area acquires 100 points per second.

When the first battle area includes a plurality of virtual objects (including a first virtual object and an allied virtual object), the virtual objects cannot be revived after being attacked and eliminated by the enemy virtual object and can only watch the battle in spectator mode.

### (2) Minion Rules

In the entire virtual match, there are a plurality of minions in the two battle areas. Therefore, a minion model having a fewer quantity of displayed model faces is selected from a set of minion models pre-stored in a server, to ensure that as many minions can be displayed as possible in the battle area. Alternatively, the quantity of minions is reduced, and only some minions are displayed.

The quantity of displayed model faces refers to a quantity of model faces of a minion being displayed in a virtual scene. If the minion model having a fewer quantity of model faces is selected, more minions can be displayed in the match area, and smoothness of the match can be ensured.

A minion may actively attack a virtual object controlled by a player.

For example, when the virtual object controlled by the player is capable of performing an attack operation on a minion, the minion can also perform an attack operation on the virtual object controlled by the player.

A minion can upgrade. Therefore, a variety of minions having different attributes corresponding to upgraded attributes needs to be pre-configured in the server.

For example, a minion in a battle area can upgrade in attributes. Therefore, a plurality of minions having different attributes as well as corresponding upgraded attribute values of the minions after upgrading are pre-configured in the server.

### 2. Scene Content 1020

A spawn point is fixed at the center of a scene.

When entering a match, a virtual object controlled by a player is displayed at the center of a scene, which is a spawn point of the virtual object.

A minion is refreshed at a random position in an area and can automatically find a route to attack a player.

During adding and displaying a minion in a battle area, the minion is displayed at a random position in a battle area, and can automatically move towards a virtual object controlled by a player and attack the virtual object.

### 3. Matchmaking Mechanism 1030

### (1) Matchmaking Time

A virtual match can be played within a specified time period every day.

### (2) Quantity of Players for Matchmaking

Solo matchmaking is allowed for a virtual match, or team matchmaking is allowed for a virtual match.

### (3) Matchmaking Object

A specified virtual object is used for matchmaking, to resolve a problem of matchmaking failure when a player does not select a controlled virtual object.

Character setting corresponding to a virtual object is displayed in the initial interface.

### (4) Rank Matchmaking Rules

During a team forming process, the matchmaking is performed according to the highest rank in the team, and a rank range gradually expands with matchmaking time.

There is no upper limit for rank matchmaking. To be specific, with enough time, matchmaking for all ranks may be successful.

Different object types are configured for a virtual object controlled by the player. Therefore, there is a type matchmaking restriction for the match. There cannot be four or more virtual objects of the same object type.

For example, refer to Table 1, which is a matchmaking configuration table.

TABLE 1

| Queue | Configuration type | Configuration value |
|---|---|---|
| 10 VS 10 match | Configuration parameter (a time interval for | 10 |
| | expanding a rank range) (second) | |
| 10 VS 10 match | Configuration parameter (an upper limit of a rank) | 20 |
| 10 VS 10 match | Configuration parameter (an upper limit of the | 4 |
| | quantity of characters of the same type) | |
| 10 VS 10 match | Maximum rank difference in team matchmaking | 5 |

### (5) Matchmaking Representation

During matchmaking, a matchmaking progress element appears on the right side.

### (6) Matchmaking Robot

Robot matchmaking logic is used during matchmaking. To be specific, when matchmaking is not successful within a specified time period, the server may automatically configure a robot for the player to play the match.

### 4. Point Rules 1040

### (1) Point Acquisition

Each time a minion is killed, a specific quantity of redemption points may be obtained. The specific quantity of redemption points obtained equals to basic redemption points of the minion plus a bonus effect generating from a first attribute effect.

If there no minion in the area, 100 redemption points are to be acquired every second during the match. When the redemption points are acquired, text “points acquired” is displayed in the virtual scene picture.

There is no upper limit for redeeming points, and the points are continuously acquired during the virtual match.

### (2) Technology (First Redemption Type)

The redemption points may be used for redeeming for a technology bonus. There are tentatively three technology bonuses: increasing a redemption point acquisition quantity or rate, increasing health of minions, and increasing attack damage of the minion.

After being redeemed, the technology takes effect permanently on minions. Effects about the redemption point acquisition rate and damage take effect immediately. The effect of increasing health of minions takes effect on minions added and displayed in a battle area.

The technology cannot be reset. Each technology has different levels, and each technology consumes a different quantity of redemption points in redemption.

When the redemption is successful, a redemption success announcement is displayed in the virtual scene picture.

### (3) Attribute Buff Effect/Attribute Debuff Effect

The redemption points may be used for redeeming for attribute effects, including attribute buff effects (effective for a virtual object controlled by a player in the first battle area) and attribute debuff effects (effective for a virtual object controlled by an opponent player in the second battle area).

The effect takes effect immediately after redemption.

The attribute buff effect/attribute debuff effect lasts for a duration, and the redemption has a cooldown duration, but there is no limitation to a quantity of redemptions.

When the redemption is successful, a redemption success announcement is displayed in the virtual scene picture.

The attribute buff effect/attribute debuff effect is a one-time effect, and a duration is configured for each attribute buff effect/attribute debuff effect.

### 5. Settlement Mechanism 1050

### (1) Single Match Reward

A winning reward may be earned within a specified quantity of matches every day. The count is added by one for each match completed.

### (2) Daily Ranking List Reward

Only rewards corresponding to the first ten winning matches are calculated, and each player is ranked according to a winning rate in virtual matches.

A protocol or rule is added to fix the problem where 11 wins were required to stop the calculation of the winning rate.

In the ranking list, ranking is performed according to the quantity of winning matches, the match winning rate, and the match duration in sequence.

Displayed fields: ranking, player, wins, winning rate, and rewards.

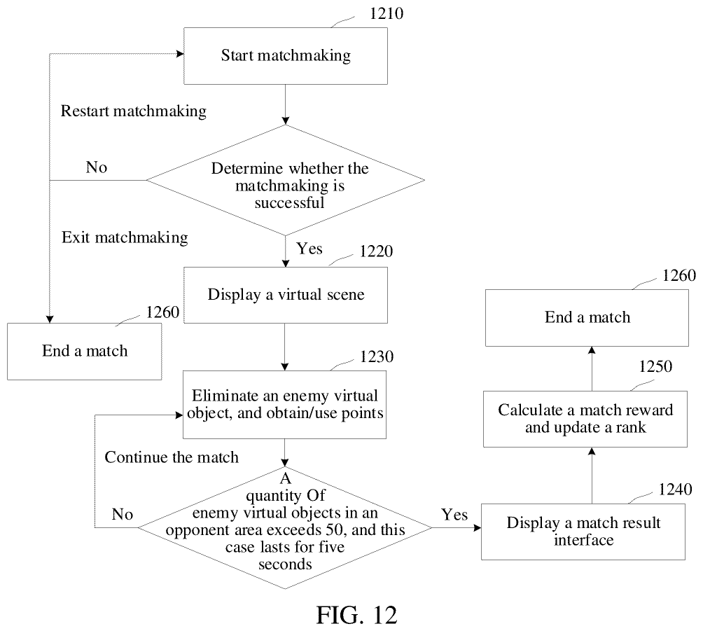

For example, refer to FIG. 12, which is a flowchart of a virtual object control method according to an exemplary aspect of this application. As shown in FIG. 12, the method includes the following steps.

Step 1210. Start matchmaking.

A player may start matchmaking by choosing solo matchmaking or team matchmaking.

If the matchmaking is successful, step 1220 is performed. If the matchmaking is not successful, step 1210 is performed again.

Step 1220. Display a virtual scene.

When the matchmaking is successful, the player enters a match interface, and a scene picture corresponding to the virtual scene is displayed. In solo matchmaking, a first virtual object controlled by the player is currently displayed in a first battle area. In team matchmaking, a first virtual object controlled by the player and a virtual object controlled by another allied player are currently displayed in a first battle area.

Step 1230. Eliminate an enemy virtual object, and obtain/use points.

The player controls a virtual object to perform an attack operation on an enemy virtual object in a battle area to eliminate the enemy virtual object, obtains redemption points after eliminating the enemy virtual object, and uses the redemption points to redeem for a match attribute effect. In this case, a server simultaneously measures a quantity of monsters in the area in real time and reports the quantity to a client. In a case that a quantity of enemy virtual objects in an opponent area exceeds 50 and this case lasts for five seconds, step 1240 is performed.

Step 1240. Display a match result interface.

Step 1250. Calculate a match reward and update a rank.

In a case that a survival quantity of enemy virtual objects in a battle area exceeds 50 and this case lasts for five seconds, it is determined that a player in an area, in which the survival quantity of enemy virtual objects is larger, loses the match.

The match result interface is displayed in a current interface, a corresponding winning/failure reward is calculated, and the rank is changed.

Step 1260. End the match.

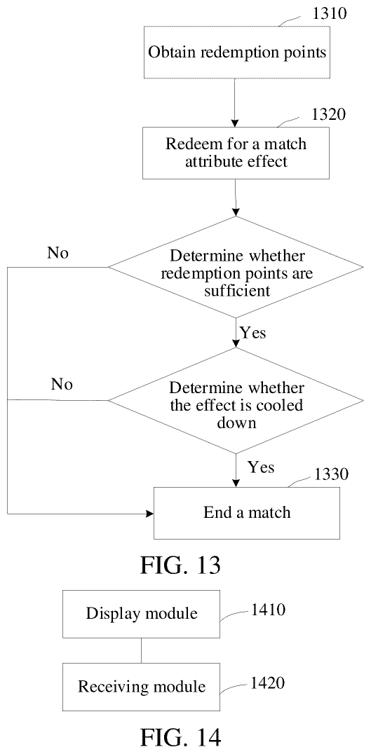

For example, refer to FIG. 13, which is a flowchart of a point redemption process according to an exemplary aspect of this application. As shown in FIG. 13, the method includes the following steps.

Step 1310. Obtain redemption points.

A player may acquire redemption points by eliminating an enemy virtual object in a virtual match or when no enemy virtual object exists in the battle area.

Step 1320. Redeem for a match attribute effect.

After acquiring the redemption points, the player redeems for different match attribute effects.

During redemption, it is first determined whether current redemption points are sufficient for redemption. If the redemption points are sufficient for redemption, it is determined whether a current attribute buff effect/debuff effect is within a cooling duration. If the current attribute buff effect/debuff effect is not within the cooldown duration, step 1330 is performed.

Step 1330. End the match.

If the current attribute buff effect/debuff effect is not within the cooldown duration, “redemption is done” is displayed.

The method provided in this application includes the following beneficial effects.

Confrontational gameplay of direct face-to-face interaction is transferred into individual battle against monsters, to innovate a confrontational gameplay mode in an MMORPG game and avoid monotonous boring experience of players. The quantity of minions slowly increases from less than ten at the beginning to 50 at the end, thereby enabling gameplay from easy to difficult, making it easy to get started with the game, and thereby improving the player experience. In addition, the introduction of points allows the player to choose a type of technology/skill for redemption, which may change a match result and increases the depth of gameplay experience.

The methods provided by this application achieve gameplay innovation, which changes the mode of monotonous face-to-face confrontation of players, making the game easy to get started with. By providing easy to difficult game modes and allowing players to the use redemption points at particular game times makes the gameplay full of fun.

FIG. 14 is a block diagram of a structure of a virtual object control apparatus according to an exemplary aspect of this application. As shown in FIG. 14, the apparatus includes the following parts:
a display module 1410, configured to display a first virtual object and a plurality of enemy virtual objects engaged in a virtual battle in a first battle area in a virtual scene, the virtual scene further including a second virtual object and a plurality of enemy virtual objects engaged in a virtual battle in a second battle area, and
the display module 1410 being further configured to add and display an enemy virtual object in the first battle area in response to that an enemy virtual object is eliminated by the second virtual object in the second battle area; and
a receiving module 1420, configured to receive an attack operation on an enemy virtual object in the first battle area, and add an enemy virtual object in the second battle area based on the eliminated enemy virtual object in the first battle area.

The display module 1410 is configured to display a virtual battle result between the first virtual object and the second virtual object based on a magnitude relationship in quantity between the enemy virtual objects in the first battle area and in the second battle area.

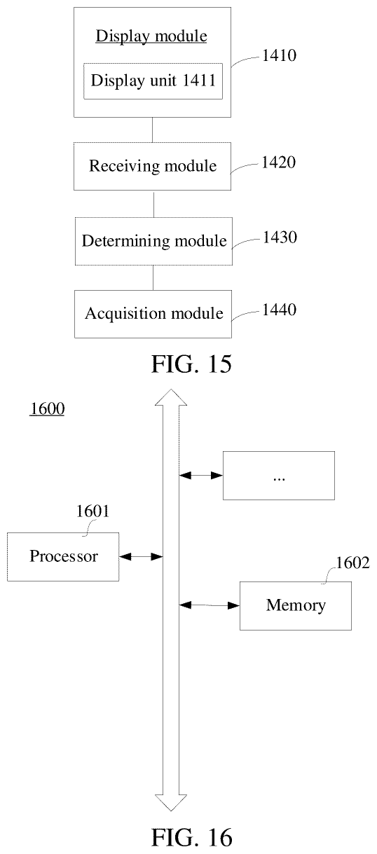

In some aspects, as shown in FIG. 15, the display module 1410 includes:
a display unit 1411, configured to display a progress indication element, the progress indication element being used for indicating survival status of enemy virtual objects in the first battle area.

The display unit 1411 is further configured to add and display an enemy virtual object in the first battle area in response to that an enemy virtual object is eliminated by the second virtual object in the second battle area, and update and display element content corresponding to the progress indication element.

In some aspects, the display module 1410 is further configured to display a countdown element in response to that survival status of the enemy virtual objects in at least one battle area satisfies a preset survival condition, the countdown element being used for indicating a remaining duration from a current moment to the end of a virtual battle.

In some aspects, the display module 1410 is further configured to display, based on the magnitude relationship in quantity between the enemy virtual objects in the first battle area and in the second battle area, the virtual battle result in response to the end of countdown indicated by the countdown element.

In some aspects, the apparatus further includes:
a determining module 1430, configured to determine an attribute value of the enemy virtual object in response to that the enemy virtual object in the first battle area is hit by the attack operation.

The display module 1410 is further configured to add and display the enemy virtual object in the second battle area in response to that the attribute value of the enemy virtual object satisfies an elimination condition.

In some aspects, the display module 1410 is further configured to count an elimination quantity of enemy virtual objects in the first battle area to obtain an elimination count result corresponding to the enemy virtual objects in the first battle area, and additionally add and display an enemy virtual objects in the second battle area and reset the elimination count result in response to that the elimination count result reaches a first quantity threshold.

In some aspects, the apparatus further includes:
the display module 1410 is further configured to display a point redemption interface, the point redemption interface including a plurality of candidate redemption options, the candidate redemption options being used for obtaining match attribute effects by redeeming points, and the points being acquired by eliminating an enemy virtual object.

The apparatus further includes an acquisition module 1440 configured to redeem, in response to receiving a triggering operation on a first redemption option, acquired points to obtain a first attribute effect corresponding to the first redemption option, the first attribute effect being used for indicating generating a first buff effect on the enemy virtual object.

In some aspects, the display module 1410 is further configured to add and display, based on the first buff effect, a target enemy virtual object in the first battle area in response to that the enemy virtual object is eliminated by the second virtual object in the second battle area. The attribute value of the target enemy virtual object corresponds to the first buff effect.

In some aspects, the acquisition module 1440 is further configured to redeem, in response to receiving a triggering operation on a second redemption option, acquired points to obtain a second attribute effect corresponding to the second redemption option, the second attribute effect being used for generating a second buff effect on the first virtual object.

In some aspects, the acquisition module 1440 is further configured to redeem, in response to receiving a triggering operation on a third redemption option, acquired points to obtain a third attribute effect corresponding to the third redemption option, the third attribute effect being used for generating an attribute debuff effect on the second virtual object.

In some aspects, the determining module 1430 is further configured to determine a redemption point acquisition rate in response to that a survival quantity of enemy virtual objects surviving in the first battle area reaches a second quantity threshold, and acquire redemption points based on the redemption point acquisition rate.

In some aspects, the display module 1410 is further configured to add and display a combined virtual object in the second battle area in response to that the elimination quantity of enemy virtual objects in the first battle area reaches a third quantity threshold, an attribute value of the combined virtual object corresponding to a sum of attribute values of the eliminated enemy virtual objects in the first battle area.

According to the virtual object control apparatus provided by aspects of this application, when there is a first battle area and a second battle area in a virtual scene, there is a first virtual object and a plurality of enemy virtual objects engaged in a virtual battle in the first battle area. There is a second virtual object and a plurality of enemy virtual objects engaged in a virtual battle in the second battle area. When an enemy virtual object in the second battle area is eliminated by the second virtual object, an enemy virtual object is added and displayed in the first battle area. Similarly, when an enemy virtual object is eliminated by the first virtual object by using an attack operation in the first battle area, an enemy virtual object is to be added and displayed in the second battle area. In other words, the first virtual object and the second virtual object eliminate enemy virtual objects in the first battle area and in the second battle area, respectively, to cause enemy virtual objects to be added and displayed in the battle area where the opponent is located. Finally, a virtual battle result is determined based on a magnitude relationship in quantity between the enemy virtual objects in the two battle areas. Therefore, diversity of virtual battle modes can be improved, and display of decrease or increase of enemy virtual objects of two parties is implemented by elimination of enemy virtual objects in each battle area, so that a player can eliminate as many enemy virtual objects as possible, thereby shortening a time length of a match, and reducing computer data overhead.

Division of the functional modules of the virtual object control apparatus provided in the foregoing aspects is merely described as an example. In actual application, the foregoing functions may be assigned according to needs to be implemented by different functional modules, that is, an internal structure of the apparatus is divided into different functional modules, so as to implement all or a part of the functions described above. In addition, the virtual object control apparatus provided in the foregoing aspects and the virtual object control method aspects fall within the same concept. Refer to method aspects for details about the specific implementation process, which are not described herein again.

FIG. 16 is a block diagram of a structure of a terminal 1600 according to an illustrative aspect of this application. The terminal 1600 may be a smartphone, a tablet computer, a Moving Picture Experts Group Audio Layer III (MP3) player, a Moving Picture Experts Group Audio Layer IV (MP4) player, a notebook computer, or a desktop computer. The terminal 1600 may also be referred to as another name such as user equipment, a portable terminal, a laptop terminal, or a desktop terminal.

Generally, the terminal 1600 includes a processor 1601 and a memory 1602.

The processor 1601 may include one or more processing cores, for example, a 4-core processor or an 8-core processor. The processor 1601 may be implemented in at least one hardware form of a digital signal processor (DSP), a field-programmable gate array (FPGA), and a programmable logic array (PLA). The processor 1601 may further include a main processor and a coprocessor. The main processor is a processor configured to process data in an awake state, and is also referred to as a central processing unit (CPU). The coprocessor is a low power consumption processor configured to process the data in a standby state. In some aspects, the processor 1601 may be integrated with a graphics processing unit (GPU). The GPU is configured to render and draw content that needs to be displayed on a display screen. In some aspects, the processor 1601 may further include an artificial intelligence (AI) processor. The AI processor is configured to process computing operations related to machine learning.

The memory 1602 may include one or more computer-readable storage media. The computer-readable storage medium may be non-transitory. The memory 1602 may further include a high-speed random access memory and a non-volatile memory, for example, one or more disk storage devices or flash storage devices. In some aspects, the non-transitory computer-readable storage medium in the memory 1602 is configured to store at least one instruction, and the at least one instruction is configured to be executed by the processor 1601 to implement the virtual match-based control method provided in the method aspects of this application.

In some aspects, the terminal 1600 further includes other components. A person skilled in the art may understand that the structure shown in FIG. 16 constitutes no limitation on the terminal 1600, and the terminal may include more or fewer components than those shown in the figure, or some components may be combined, or a different component deployment may be used.

A person of ordinary skill in the art may understand that all or some of the steps of the methods in the foregoing aspects may be implemented by a program instructing relevant hardware. The program may be stored in a computer-readable storage medium. The computer-readable storage medium may be the computer-readable storage medium included in the memory in the foregoing aspect, or may be a computer-readable storage medium that exists independently and that is not installed in a terminal. The computer-readable storage medium has at least one instruction, at least one program, a code set or an instruction set stored thereon, the at least one instruction, the at least one program, the code set or the instruction set being loaded and executed by the processor to implement the virtual object control method according to any one of the foregoing aspects.

What is claimed is:

1. A computer-assisted method comprising:
instantiating a first virtual object and a first plurality of enemy virtual objects engaged in a virtual battle in a first battle area in a virtual scene, the virtual scene further comprising a second virtual object and a second plurality of enemy virtual objects engaged in a virtual battle in a second battle area;
adding, in response to an enemy virtual object being eliminated by the second virtual object in the second battle area, the enemy virtual object in the first battle area;
receiving an attack operation on an enemy virtual object in the first battle area, and adding, in response to the enemy virtual object being eliminated in the first battle area, the enemy virtual object in the second battle area; and
determining a virtual battle result between the first virtual object and the second virtual object based on comparison of a quantity of the enemy virtual objects in the first battle area and in the second battle area.

2. The method according to claim 1, wherein the adding comprises:
determining a progress indication element, the progress indication element being responsive to and based on a survival status of the enemy virtual objects in the first battle area; and
updating the progress indication element based on a change in the survival status of the enemy virtual objects in the first battle area.

3. The method according to claim 2, further comprising:
generating a countdown element in response to the survival status of the enemy virtual objects in at least one battle area satisfying a preset survival condition, the countdown element being based on a remaining duration from a current moment to an end of a virtual battle; and
determining the virtual battle result in response to the end of a countdown indicated by the countdown element.

4. The method according to claim 1, further comprising:
determining an attribute value of the enemy virtual object in response to the enemy virtual object in the first battle area being hit by the attack operation; and
adding the enemy virtual object in the second battle area in response to the attribute value of the enemy virtual object satisfying an elimination condition.

5. The method according to claim 1, wherein after the receiving the attack operation on the enemy virtual object in the first battle area, the method further comprises:
counting an elimination quantity of the enemy virtual objects in the first battle area to obtain an elimination count result corresponding to the enemy virtual objects in the first battle area; and
adding an additional enemy virtual object in the second battle area and resetting the elimination count result, in response to the elimination count result reaching a first quantity threshold.

6. The method according to claim 1, further comprising:
generating a point redemption interface, the point redemption interface comprising a plurality of candidate redemption options, the candidate redemption options being used for obtaining match attribute effects by redeeming points, and the points being acquired by eliminating the enemy virtual objects; and
redeeming, in response to receiving a triggering operation on a first redemption option, acquired points to obtain a first attribute effect corresponding to the first redemption option, the first attribute effect being used for generating a first buff effect on the enemy virtual objects.

7. The method according to claim 6, further comprising:
adding a target enemy virtual object in the first battle area based on the first buff effect in response to an enemy virtual object being eliminated by the second virtual object in the second battle area, an attribute value of the target enemy virtual object corresponding to the first buff effect.

8. The method according to claim 6, further comprising:
redeeming, in response to receiving a triggering operation on a second redemption option, acquired points to obtain a second attribute effect corresponding to the second redemption option, the second attribute effect being used for generating a second buff effect on the first virtual object.

9. The method according to claim 6, further comprising:
redeeming, in response to receiving a triggering operation on a third redemption option, acquired points to obtain a third attribute effect corresponding to the third redemption option, the third attribute effect being used for generating an attribute debuff effect on the second virtual object.

10. The method according to claim 6, further comprising:
determining a redemption point acquisition rate in response to that a survival quantity of the enemy virtual objects in the first battle area reaches a second quantity threshold; and
acquiring the redemption points based on the redemption point acquisition rate.

11. The method according to claim 1, further comprising:
adding a combined virtual object in the second battle area in response to the elimination quantity of the enemy virtual objects in the first battle area reaching a third quantity threshold, wherein an attribute value of the combined virtual object corresponds to a sum of attribute values of the eliminated enemy virtual objects in the first battle area.

12. One or more non-transitory computer readable media storing computer readable instructions which, when executed by a processor, configure a data processing system to execute a virtual object control method, comprising:
instantiating a first virtual object and a first plurality of enemy virtual objects engaged in a virtual battle in a first battle area in a virtual scene, the virtual scene further comprising a second virtual object and a second plurality of enemy virtual objects engaged in a virtual battle in a second battle area;
adding, in response to an enemy virtual object being eliminated by the second virtual object in the second battle area, the enemy virtual object in the first battle area;
receiving an attack operation on an enemy virtual object in the first battle area, and adding, in response to the enemy virtual object being eliminated in the first battle area, the enemy virtual object in the second battle area; and
determining a virtual battle result between the first virtual object and the second virtual object based on comparison of a quantity of the enemy virtual objects in the first battle area and in the second battle area.

13. The computer readable media according to claim 12, wherein the adding comprises:
determining a progress indication element, the progress indication element being responsive to and based on a survival status of the enemy virtual objects in the first battle area; and
updating the progress indication element based on a change in the survival status of the enemy virtual objects in the first battle area.

14. The computer readable media according to claim 12, further comprising:
determining an attribute value of the enemy virtual object in response to the enemy virtual object in the first battle area being hit by the attack operation; and
adding the enemy virtual object in the second battle area in response to the attribute value of the enemy virtual object satisfying an elimination condition.

15. The computer readable media according to claim 12, further comprising:
counting an elimination quantity of the enemy virtual objects in the first battle area to obtain an elimination count result corresponding to the enemy virtual objects in the first battle area; and
adding an additional enemy virtual object in the second battle area and resetting the elimination count result, in response to the elimination count result reaching a predetermined quantity threshold.

16. The computer readable media according to claim 12, further comprising:
generating a point redemption interface, the point redemption interface comprising a plurality of candidate redemption options, the candidate redemption options being used for obtaining match attribute effects by redeeming points, and the points being acquired by eliminating the enemy virtual objects; and
redeeming, in response to receiving a triggering operation on a first redemption option, acquired points to obtain a first attribute effect corresponding to the first redemption option, the first attribute effect being used for generating a first buff effect on the enemy virtual objects.

17. The computer readable media according to claim 16, further comprising:
redeeming, in response to receiving a triggering operation on a second redemption option, acquired points to obtain a second attribute effect corresponding to the second redemption option, the second attribute effect being used for generating an attribute debuff effect on the second virtual object.

18. The computer readable media according to claim 12, further comprising:
adding a combined virtual object in the second battle area in response to the elimination quantity of the enemy virtual objects in the first battle area reaching a predetermined quantity threshold, wherein an attribute value of the combined virtual object corresponds to a sum of attribute values of the eliminated enemy virtual objects in the first battle area.

19. A data processing system, comprising:
a processor; and
memory storing computer readable instructions which, when executed by the processor, configure the data processing system to execute a virtual object control method, comprising:
instantiating a first virtual object and a first plurality of enemy virtual objects engaged in a virtual battle in a first battle area in a virtual scene, the virtual scene further comprising a second virtual object and a second plurality of enemy virtual objects engaged in a virtual battle in a second battle area;
adding, in response to an enemy virtual object being eliminated by the second virtual object in the second battle area, the enemy virtual object in the first battle area;
receiving an attack operation on an enemy virtual object in the first battle area, and adding, in response to the enemy virtual object being eliminated in the first battle area, the enemy virtual object in the second battle area; and
determining a virtual battle result between the first virtual object and the second virtual object based on comparison of a quantity of the enemy virtual objects in the first battle area and in the second battle area.

20. The computer readable media according to claim 19, further comprising:
counting an elimination quantity of the enemy virtual objects in the first battle area to obtain an elimination count result corresponding to the enemy virtual objects in the first battle area;
adding an additional enemy virtual object in the second battle area and resetting the elimination count result, in response to the elimination count result reaching a first quantity threshold;
adding a combined virtual object in the second battle area in response to the elimination quantity of the enemy virtual objects in the first battle area reaching a second quantity threshold, wherein an attribute value of the combined virtual object corresponds to a sum of attribute values of the eliminated enemy virtual objects in the first battle area;
generating a point redemption interface, the point redemption interface comprising a plurality of candidate redemption options, the candidate redemption options being used for obtaining match attribute effects by redeeming points, and the points being acquired by eliminating the enemy virtual objects; and
redeeming, in response to receiving a triggering operation on a first redemption option, acquired points to obtain a first attribute effect corresponding to the first redemption option, the first attribute effect being used for generating a first buff effect on the enemy virtual objects.
